(19) United States
(12) Patent Application Publication
(10) Pub. No.: US 2006/0098344 A1
(43) Pub. Date: May 11, 2006

(54) Method and apparatus providing head suspension sag control reducing off-track motion due to disk flutter in a hard disk drive

(76) Inventors: Frank Morris, San Jose, CA (US); Shiao Hua Chen, Palo Alto, CA (US); Joseph Chang, San Jose, CA (US); Myeong Eop Kim, San Jose, CA (US)

Correspondence Address: GSS LAW GROUP, Suite 317, 3900 Newpark Mall Road, Newark, CA, 94560, US

(21) Appl. No.: 10/982,147

(22) Filed: Nov. 5, 2004

(51) Int. Cl. G11B 21/16; G11B 5/48

(52) U.S. Cl. 360/244.9

(57) ABSTRACT

The present invention includes the following. Load beams for head suspension assemblies optimally providing head gimbal assemblies with the ability to minimize the effects of disk vibration from rotating disk surfaces during the track following sequences. Operating at least a head gimbal assembly as follows, when the read-write head is following a track. The sag control region of the load beam adjusts the roll center to coincide with the center of the rotating disk. The head gimbal assembly compensates through the roll center for disk flutter, causing the read-write head to follow the track. This reduces off-track motion, minimizing Track Mis-Registration. Making head suspension assemblies, head gimbal assemblies, actuator arms, actuator assemblies and hard disk drives using these load beams. The components are also products of the invention's manufacturing methods.

### BACKGROUND OF THE INVENTION

1. Field of the Invention

The present invention relates to head gimbal assemblies, particularly head suspension assemblies, and the load beam of head suspension assemblies in a hard disk drive.

2. Background Information

Hard disk drives contain one or more magnetic heads coupled to rotating disks. The heads write and read information by magnetizing and sensing the magnetic fields of the disk surfaces. Typically, magnetic heads have a write element for magnetizing the disks and a separate read element for sensing the magnetic field of the disks. The read element is typically constructed from a magneto-resistive material. The magneto-resistive material has a resistance that varies with the magnetic fields of the disk. Heads with magneto-resistive read elements are commonly referred to as magneto-resistive (MR) heads.

Each head is embedded in a slider. The slider mechanically couples to an actuator arm by a head suspension assembly. The head suspension assembly includes a load beam connected to the actuator arm by a spring or hinge coupling. The slider is attached to a flexure arm and the flexure is attached to the load beam to form a head gimbal assembly (HGA). The head gimbal assembly includes the head suspension assembly, the flexure and the slider. Each HGA in a hard disk drive attaches to an actuator arm by the hinge coupling. The actuator arms rigidly couples to a voice coil motor that moves the heads across the surfaces of the disks.

Information is stored in radial tracks that extend across the surfaces of each disk. Each track is typically divided into a number of segments or sectors. The voice coil motor and actuator arm can move the heads to different tracks of the disks and to different sectors of each track.

A suspension interconnect extends along the length of the flexure and connects the head to a preamplifier. The suspension interconnect typically comprises a pair of conductive write traces and a pair of conductive read traces.

The Tracks Per Inch (TPI) in hard disk drives is rapidly increasing, leading to smaller and smaller track positional tolerances. The track position tolerance, or the offset of the read-write head from a track, is monitored by a signal known as the head Positional Error Signal (PES). Reading a track successfully usually requires minimizing read-write head PES occurrences. The allowable level of PES is becoming smaller and smaller. A substantial portion of the PES is caused by disk vibration.

Track Mis-Registration occurs when a read-write head tends to lose the track registration. This occurs when the disk surface bends up or down. Track Mis-Registration is often a statistical measure of the positional error between a read-write head and the center of an accessed track.

One basic prior art approach lowers the Track Mis-Registration due to disk vibration by using head gimbal assemblies to provide a radial motion capability.

The head gimbal assembly, including a biased load beam, creates a roll center (also known as a dimple center), which provides a radial motion capability as the load beam moves vertically due to disk vibration. This allows sliders to move in a radial direction as well as in a vertical direction with respect to the disks, reducing off-track motion due to disk vibration.

This approach has some problems. An air bearing forms between the slider face and the disk surface. The slider face is tilted near the disk surface when it is flat. The air bearing becomes non-uniform when the disk surface is flat, adding new mechanical instabilities into the system.

One alternative prior art head gimbal assembly provides a slider mounted so that it pivots in the radially oriented plane about the effective roll axis, which is located within the disk. This scheme does not cause a non-uniform air bearing when the disk surface is flat. However, the way the effective roll axis is placed inside the disk requires a more complex mechanical coupling between the slider support assembly and the slider. This complex mechanical coupling may have a greater probability of mechanical failure, tending to increase manufacturing expenses and to reduce hard disk drive life expectancy.

Accordingly, there exists a need for head gimbal assembly mechanisms providing a stable air bearing. These mechanisms need to follow a track when a disk surface bends. The mechanisms need to be easy and reliable to manufacture, without requiring additional mechanical complexity or extensive modifications to existing head gimbal assemblies.

### BRIEF SUMMARY OF THE INVENTION

The present invention includes load beams for head suspension assemblies of hard disk drives. These head suspension assemblies optimally provide head gimbal assemblies with the ability to minimize the effects of disk vibration from rotating disk surfaces during the track following sequences, when the track may be accessed.

The load beam includes a sag control region, providing a concave plate between its hinge mount and its slider mount. When used in a head gimbal assembly, the concave plate curves toward the rotating disk surface which is accessed by the read-write head. The read-write head mounts on the head suspension assembly containing the load beam. The sag control region adjusts the roll center of the head gimbal assembly into the plane of the disk and near the center of the rotating disk.

The method of operating the head gimbal assembly when the read-write head is following a track includes the following steps. The sag control region of the load beam adjusts the roll center to coincide with the center of the rotating disk. The head gimbal assembly through the roll center compensates for flutter in the rotating disk surface, causing the read-write head to follow the track. This compensating for flutter, results in reduced off-track motion, which minimizes Track Mis-Registration.

The invention includes making head suspension assemblies, head gimbal assemblies, actuator arms, actuator assemblies and hard disk drives using these load beams. The head suspension assemblies, head gimbal assemblies, actuator arms, actuator assemblies and hard disk drives made with these load beams are also products of the invention's manufacturing methods.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, in which:

FIGS. 1A and 1B show a typical load beam with a roll center as close to the gimbal as possible;

FIGS. 1C and 1D show the invention reducing off-track motion due to disk flutter by a load beam including a sag control region;

FIG. 2A shows a schematic view of the head gimbal assembly of FIGS. 1A to 1D, with the slider enlarged, showing the read-write head.

FIG. 2B shows the relationship between the disk hub, the actuator axis and the actuator arm, which couples with the head gimbal assembly of FIGS. 1C to 1D, to position the slider to follow a track on the rotating disk surface;

FIGS. 3A and 3B show a typical prior art head gimbal assembly in cross section;

FIGS. 3C and 3D show the invention's head gimbal assembly in cross section while operating;

FIG. 3E shows the head suspension assembly including the invention's load beam with sag control region, providing a concave plate between its hinge mount and slider mount;

FIG. 4 shows a top view of the head gimbal assembly of FIGS. 1C, 1D with the electrical interconnect carried by the flexure for the read-write head on the slider;

FIG. 5 shows a hard disk drive including a disk drive controller;

FIG. 6 shows a hard disk drive including multiple actuator arms, each coupled with its own head gimbal assembly preferably using the load beams of the invention.

### DESCRIPTION OF THE PREFERRED EMBODIMENTS

The following description is provided to enable any person skilled in the art to make and use the invention and sets forth the best modes presently contemplated by the inventors for carrying out the invention. Various modifications, however, will remain readily apparent to those skilled in the art, since the generic principles of the present invention have been defined herein.

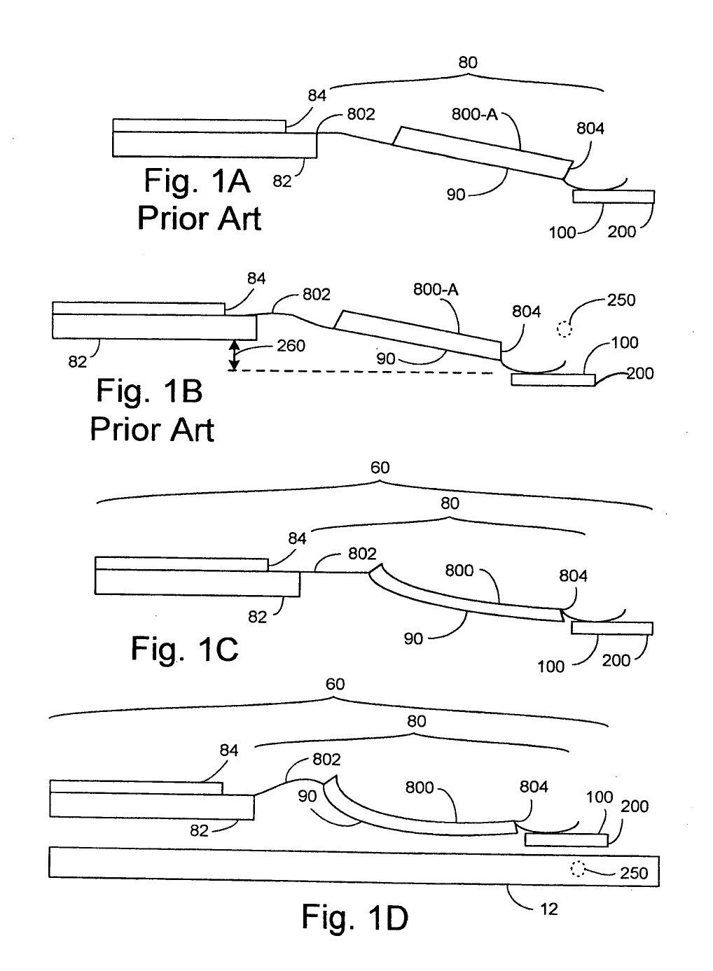

FIGS. 1A and 1B show a typical load beam 80 with a roll center 250 as possible, as close to the gimbal. Having the roll center 250 close to the gimbal tends to reduce possible wind effects on the load beam 80. However, during a track following sequence, disk vibration modes often translate into off track motion by the slider 100. This is due to the angle made by the disk 12 with respect to the disk center axis. The off-track motion is proportional to this angle by a constant.

Several approaches reduce or eliminate disk flutter in the operating condition. Most require additional parts or special modification to existing arms or suspensions. The invention includes a new method that allows quick and easy modification of the existing suspension design and at least reduces off-track motion due to the disk flutter. In this method, no additional parts are needed.

FIGS. 1C and 1D show the invention's method for reducing off-track motion due to disk flutter. The head gimbal assembly 60 includes a sag control region 800. The sag control region 800 alters the suspension so that the roll center 250 is located on the center of disk thickness, not at the usual suspension gimbal area 60. By vertically controlling the suspension's center of gravity, the roll center 250 can be made to coincide with the center of disk 12. Off-track motion of the slider 100 is minimized when the suspension roll center 250 is near the disk center. The head gimbal assembly 60 essentially includes a head suspension assembly electrically and mechanically coupled to the slider 100 through the flexure 90 and/or load beam 800.

The head gimbal assembly 60 of FIGS. 1C and 1D includes the load beam 80. The load beam 80 includes a sag control region 800, providing a concave plate between its hinge mount 802 and its slider mount 804. When used in a head gimbal assembly 60, the concave plate 800 curves toward the rotating disk surface 12, which is accessed by the read-write head 200. The read-write head 200 is embedded in the slider 100. The slider 100 mounts on the head suspension assembly, which includes the load beam 80, the hinge plate 82, and the base plate 84. The slider 100 is electrically and mechanically coupled with the flexure 90. The sag control region 800 adjusts the roll center 250 of the head gimbal assembly 60 into the plane, and near the center of, the rotating disk 12. The head suspension assembly, when coupled with the slider 100, becomes the head gimbal assembly 60. In these and the following Figures, the reference number 60 will also refer to the head suspension assembly, which essentially becomes the head gimbal assembly with the coupling of the slider 100.

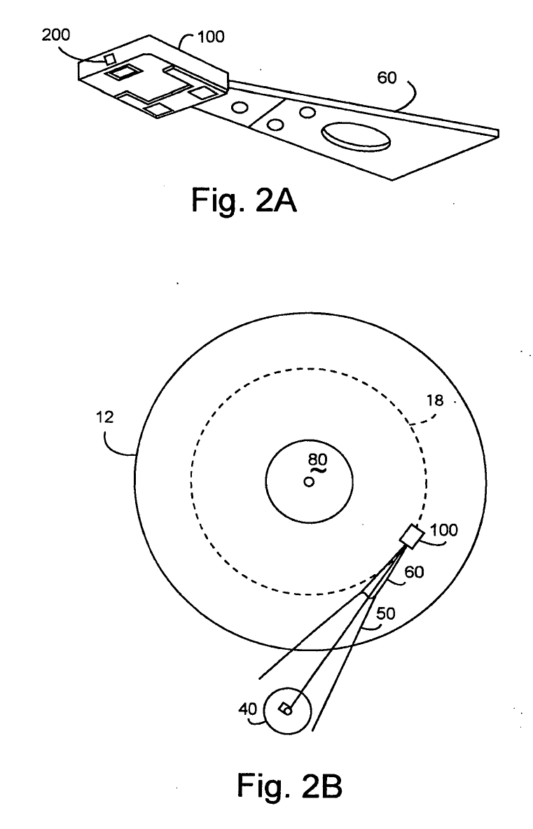

FIG. 2A shows a schematic view of the head gimbal assembly 60 of FIGS. 1C to 1D, with the slider 100 enlarged, showing the read-write head 200. FIG. 2B shows the relationship between the disk hub 80, and the actuator axis 40, actuator arm 50. The actuator arm 50 couples with head gimbal assembly 60 to position the slider 100 to follow track 18 on the rotating disk surface 12.

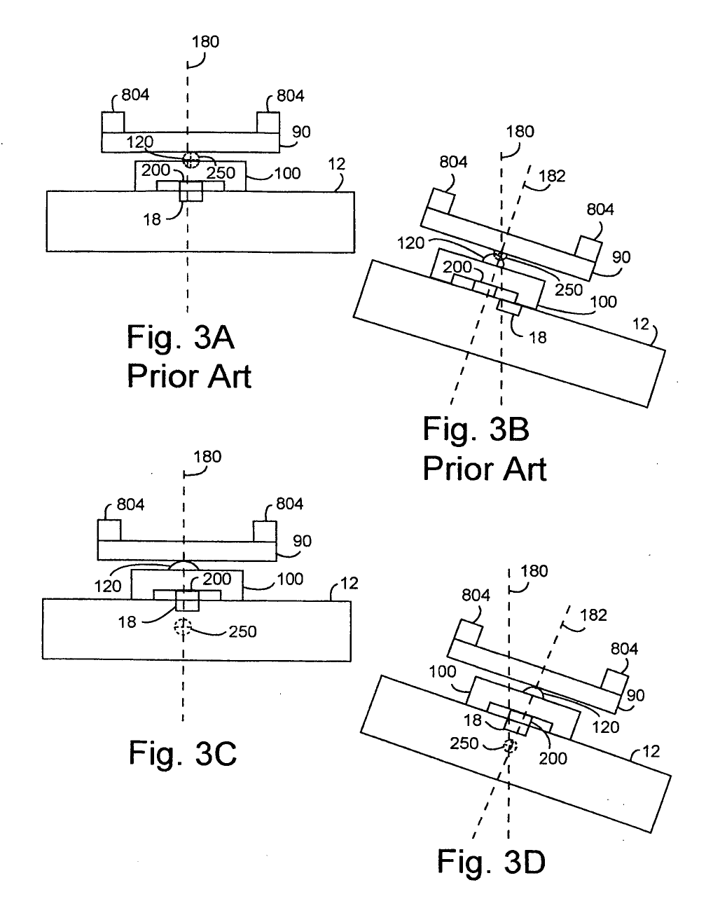

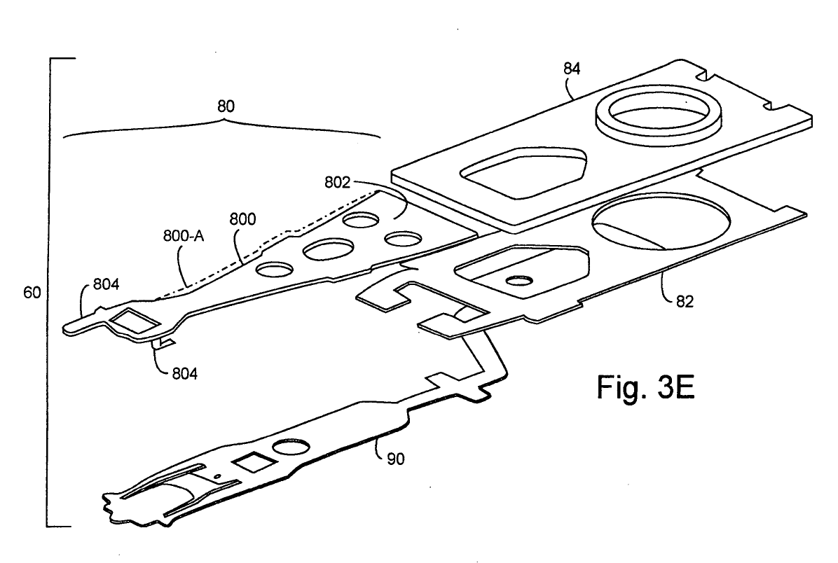

FIGS. 3A and 3B show a typical prior art head gimbal assembly in cross section. FIG. 3A shows the roll center 250 located essentially on the gimbal. FIG. 3B shows the roll motion 182 of the head gimbal assembly through the roll center 250 during disk flutter, causing the read-write head 200 to move away from track 18. This is a schematic representation of off-track motion due to disk vibration, which causes Track Mis-Registration.

FIGS. 3C and 3D show the invention in operation. These Figures show operating the head gimbal assembly 60 of FIGS. 1C to 2B, when the read-write head 200 is following a track 18. The sag control region 800 of the load beam 80 adjusts the roll center 250 to coincide with the center of the rotating disk 12 as shown in both Figures. The head gimbal assembly 60, through the roll center 250, compensates for flutter in the rotating disk surface 12 as shown in FIG. 3D, causing the read-write head 200 to follow the track 18. This compensating for flutter results in reduced off-track motion, minimizing Track Mis-Registration.

FIG. 3E shows the head suspension assembly 60 of FIGS. 1C to 2B, 3C and 3D, including the invention's load beam 80 with sag control region 800, providing a concave plate between its hinge mount 802 and slider mount 804. Note that the typical prior art load beam differs only in the flat plate 800-A between its hinge mount 802 and slider mount 804. This difference is significant for at least two reasons. The cost of making the load beam 80 of the invention is essentially identical to typical existing load beams. The rest of the head suspension, head gimbal assembly, actuator arm, actuator assembly and hard disk drive are not mechanically or electrically altered to achieve the reduction of Track Mis-Registration due to disk vibration. By way of example, in a load beam of 14.5 mm in length, the difference between the concave plate 800 and the flat plat 800-A has a preferred maximum of 0.035 inch.

In FIG. 3E, the head gimbal assembly 60, which includes the load beam 80 of the invention, as well as a hinge plate 82 and a base plate 84. The making of the head suspension assembly includes attaching the load beam 80 at the hinge mount 802 to the hinge plate 82. The hinge plate 82 is attached to the base plate 84. The flexure 90 is attached to at least the load beam 80. The head gimbal assembly 60 further includes slider 100, not shown, connected electrically and mechanically to the flexure 90 under the slider mount 804.

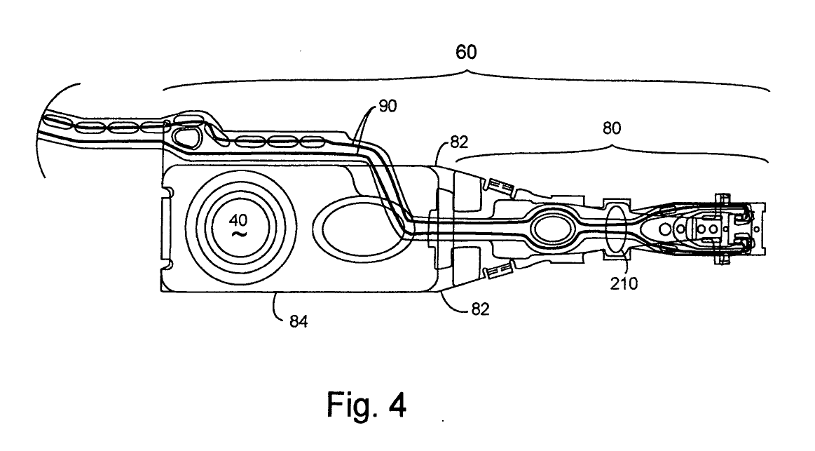

FIG. 4 shows a top view of the head gimbal assembly 60 with electrical interconnect 210 carried by the flexure 90 for the read-write head 200 on the slider 100. The slider 100 and its read-write head 200 are not shown.

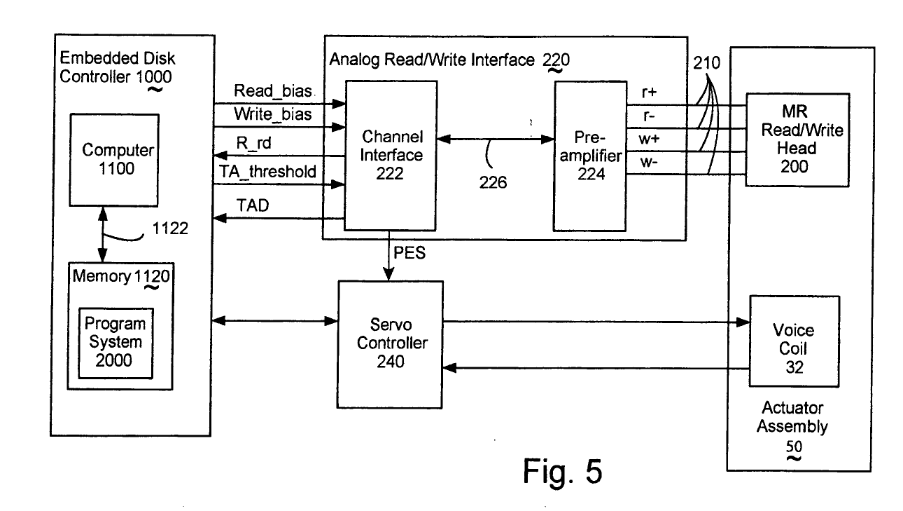

The hard disk drive 10 may further include a disk drive controller 1000 as in FIG. 5. The disk drive controller 1000 communicates with the analog read-write interface 220, which in turn communicates the resistivity found in the spin valve within the read-write head 200 to the controller 1000. The analog read-write interface 220 frequently includes a channel interface 222 communicating 226 with pre-amplifier 224. The channel interface 222 receives commands from the embedded disk controller 1000, setting the read_bias and write_bias. The hard disk drive analog read-write interfaces 220 may employ either a read current bias or a read voltage bias. For example, the resistance of the read head is determined by measuring the voltage drop (V_rd) across the read differential signal pair (r+ and r−), based upon the read bias current (read_bias), using Ohm's Law.

In FIG. 5, the channel interface 222 provides a Position Error Signal (PES) to the servo controller 240. The servo controller 240 drives a voice coil 32 to keep the read-write head 200 close enough to a track (such as track 18 of FIG. 1), to support accessing the track.

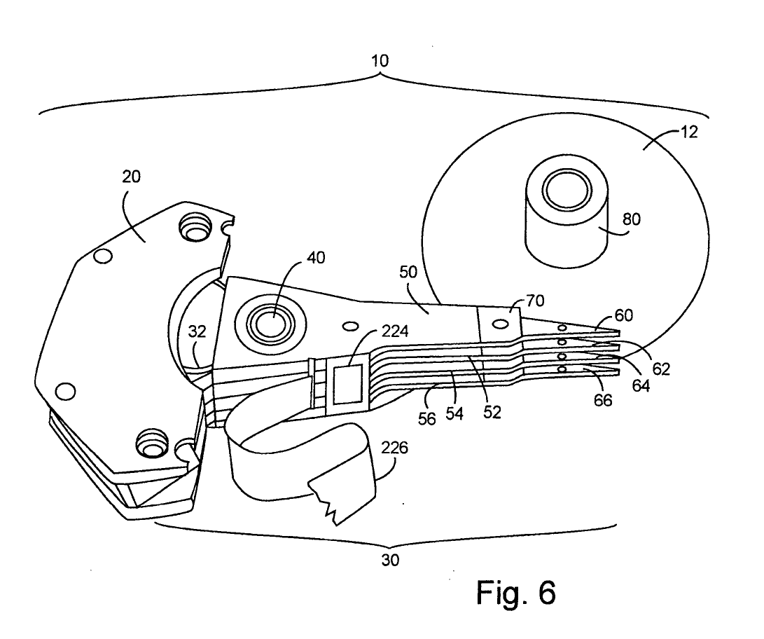

FIG. 6 shows a hard disk drive 10 including multiple actuator arms 50-56, each coupled with its own head gimbal assembly 60 to 66, respectively. Each of these head gimbal assemblies preferably includes the load beam 80 of the invention as previously shown in FIGS. 1C, 1D, and 3E. The voice coil 32 is rigidly coupled with these actuator arms 50-56, to provide essentially planar motion of rotating disk surfaces, of which only 12 is shown. This planar motion pivots the slider 100 by a lever action through actuator axis 40, as shown in FIGS. 2B and 6. The planar motion positions the read-write head 200 to follow track 18 on the rotating disk surface.

Each actuator arm 50 in FIG. 6 attaches to the head gimbal assembly 60 by a coupling region 70. In certain embodiments of the invention, the base plate 84 of the head gimbal assembly 60 shown in FIG. 3E provides the top layer of coupling region 70. Alternatively, it may be preferred that an additional plate provides the top layer of coupling region 70.

The actuator assembly 30 in FIG. 6 often includes at least one actuator arm 50 with coupled head gimbal assembly 60, further coupled by the voice coil 32. The actuator arms 50 pivot through actuator axis 40 based upon the voice coil 32 interacting with permanent magnet 20. The actuator assembly further includes an electrical coupling 226 to preamplifier 224 of FIG. 5. The preamplifier 224 electrically couples via a flexure 90 to each read-write head 200 of the sliders 100 in the head gimbal assemblies 60 to 68.

The hard disk drive 10 of FIGS. 5 and 6 includes a permanent magnet 20, propelling voice coil 32, based upon controls initiated by servo controller 240. The lever action of voice coil 32 through actuator axis 40, causes the actuator arms 50 to move the read-write heads 200. The load beam 80 of FIGS. 1C, 1D, and 3E causes the head gimbal assembly 60 to roll during disk vibration. This roll center motion of the head gimbal assembly 60 causes read-write head 200 to follow tracks 18 over their rotating disk surfaces 12 during disk flutter, as shown in FIG. 3D.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A load beam for use in a head gimbal assembly including:
a sag control region, providing a concave plate between a hinge mount and a slider mount;
wherein said concave plate curves toward a surface of a rotating disk, when said head gimbal assembly includes a read-write head accessing a track on said rotating disk surface;
wherein said sag control region adjusts a roll center of said head gimbal assembly into and near a center of said rotating disk.

2. A head suspension assembly for use in said head gimbal assembly of claim 1, including:
said load beam, attached by said hinge mount to a hinge plate; and
said hinge plate attached to at least one base plate.

3. The apparatus of claim 2, further including: a flexure coupled with said load beam.

4. Said head gimbal assembly of claim 3, further including:
a slider coupled with said flexure near said slider mount of said load beam;
wherein said slider coupled with said flexure includes a read-write head communicating via a read differential signal pair and a write differential signal pair.

5. An actuator arm, including said head gimbal assembly of claim 4.

6. An actuator assembly, including:
at least one actuator arm electrically coupled with a preamplifier, further comprising:
said preamplifier electrically coupled to said read differential signal pair and electrically coupled to said write differential signal pair, for said read-write head included in at least one of said sliders in at least one of said actuator arms.

7. The apparatus of claim 6, further comprising said preamplifier electrically coupled to said read differential signal pair and electrically coupled to said write differential signal pair, for said read-write head included in each of said sliders in each of said actuator arms.

8. An actuator assembly including at least one actuator arm of claim 6, further comprising:
a voice coil rigidly coupled with said actuator arm to provide a lever action through an actuator axis; and
a permanent magnet providing a means for propelling voice coil to provide said lever action.

9. A hard disk drive, comprising: said actuator assembly of claim 8 electrically coupled to an embedded disk controller driving said voice coil.

10. The apparatus of claim 9, wherein said actuator assembly electrically coupled to said embedded disk controller is further comprised of:
said preamplifier electrically coupled with a channel interface;
said channel interface provides an Positional Error Signal (PES) to a servo-controller; and
said servo-controller drives said voice coil based upon at least said PES during said read-write head following said track.

11. The method of operating a head gimbal assembly when a read-write head is following a track on a rotating disk surface within a hard disk drive, comprising the steps of:
a sag control region of a load beam in said head gimbal assembly adjusting a roll center to coincide with a center of said rotating disk;
said head gimbal assembly compensating through the roll center for flutter in said rotating disk surface, causing said read-write head to follow said track.

12. A head gimbal assembly implementing the method of claim 11, comprising:
means for said sag control region of said load beam adjusting said roll center to coincide with said rotating disk center;
means for said head gimbal assembly compensating through said roll center for flutter in said rotating disk surface, causing said read-write head to follow said track.

13. An actuator implementing the method of claim 11, comprising:
means for said sag control region of said load beam in at least one head gimbal assembly adjusting said roll center to coincide with said rotating disk center;
means for said head gimbal assembly compensating through said roll center for flutter in said rotating disk surface, causing said read-write head to follow said track.

14. A hard disk drive implementing the method of claim 11, comprising:
means for said sag control region of said load beam in at least one head gimbal assembly in at least one actuator arm, adjusting said roll center to coincide with said rotating disk center;
means for said head gimbal assembly compensating through said roll center for flutter in said rotating disk surface, causing said read-write head to follow said track.

15. A method of making a head suspension assembly for use in a hard disk drive, using load beam with a sag control region, providing a concave plate between a hinge mount and a slider mount, comprising the steps of:
attaching said load beam to a hinge plate, further comprising the step of attending said hinge mount to said hinge plate; and
attaching said hinge plate attached to at least one base plate;
wherein said concave plate curves toward a surface of a rotating disk, when said head suspension assembly is included in a head gimbal assembly includes a read-write head accessing a track on a rotating disk surface; and
attaching said load beam to a hinge plate, further comprising the step of attending said hinge mount to said hinge plate; and
attaching said hinge plate attached to at least one base plate;
wherein said concave plate curves toward a surface of a rotating disk, when said head suspension assembly is included in a head gimbal assembly includes a read-write head accessing a track on a rotating disk surface; and
wherein said sag control region adjusts a roll center of said head gimbal assembly into and near a center of said rotating disk.

16. A method of making a head gimbal assembly using said head suspension assembly of claim 15, comprising the steps of:
coupling a flexure with said load beam; and
electrically coupling a read differential signal pair and a write differential signal pair with a read-write head embedded in a slider mechanically coupled with said flexure.

17. A method of making an actuator arm using said head gimbal assembly of claim 16, comprising the steps of:
mechanically coupling said actuator with said head gimbal assembly.

18. A method of making an actuator assembly using at least one said actuator arms of claim 17, comprising the steps of:
electrically coupling at least one actuator arm a preamplifier, further comprising, for at least one of said actuator arms used in said actuator assembly, the steps of:
electrically coupling said preamplifier said read differential signal pair and to said write differential signal pair, for said read-write head included in at least one of said sliders in at least one of said actuator arms.

19. A method of making a hard disk drive using at least one said actuator assemblies of claim 17, comprising the steps of:
electrically coupling said preamplifier to an embedded disk controller driving a voice coil propelled by a permanent magnet in a lever action through an actuator axis to provide a read-write head following a track on a rotating disk surface;
wherein said concave plate curves toward a surface of a rotating disk, when said head suspension assembly is included in a head gimbal assembly includes a read-write head accessing a track on a rotating disk surface; and
wherein said sag control region adjusts a roll center of said head gimbal assembly into and near a center of said rotating disk.

20. Said hard disk drive as a product of the process of claim 19.

21. Said actuator assembly as a product of the process of claim 18.

22. Said actuator arm as a product of the process of claim 17.

23. Said head gimbal assembly as a product of the process of claim 16.

24. Said head suspension assembly as a product of the process of claim 15.

25. Said head suspension assembly as a product of the process of claim 18.
